(19) United States
(12) Patent Application Publication
(10) Pub. No.: US 2008/0309768 A1
(43) Pub. Date: Dec. 18, 2008

(54) IPOD's additional function device

(76) Inventor: Chieh Lin Chung, Tainan Hsien (TW)

Correspondence Address: BACON & THOMAS, PLLC, 625 SLATERS LANE, FOURTH FLOOR, ALEXANDRIA, VA, 22314-1176, US

(21) Appl. No.: 11/808,609

(22) Filed: Jun. 12, 2007

(51) Int. Cl. H04N 5/225

(52) U.S. Cl. 348/207.11; 348/E05.024

(57) ABSTRACT

An iPod's additional function device includes a fitting base for receiving an iPod in its hollow space, a lens and a shutter provided on the fitting base, and an interface adapter provided on the fitting base to connect to the connection interface of the iPod so that the iPod has an additional function of a camera for taking photos and pictures besides the original functions of the iPod itself.

### BACKGROUND OF THE INVENTION

1. Field of the Invention

This invention relates to an additional function device for an iPod, particularly to one provided with a function of a camera for taking photos and pictures.

2. Description of the Prior Art

An iPod is an advanced musical walkman, which is provided with functions of displaying video and audio data, notebook data, MP3 and a very large memory (about 40 GB or 60 GB). As shown in FIG. 1, it includes a body 1, a display screen 10, two buttons 11 and 12. The body 1 is provided with an electric circuit and various electronic components for controlling various functions of displaying video and audio data, notebook data and MP3, and the display screen 10 is fixed on a front side of the body 1 for displaying the data, handled by the buttons 11 and 12 that are also fixed on the front side of the body 1. Though the iPod has such a very large memory almost as that of a digital camera, it has no function of taking photos or pictures,

### SUMMARY OF THE INVENTION

This invention has been devised to offer an iPod added with a function device for taking photos or pictures.

The feature of the invention is a fitting base fitted with a rear sidewall of an iPod and provided with an interface adapter fixed at its bottom side for matching with the connection interface of an iPod for transmitting data, and a lens fixed on a inner wall of the fitting base, and a shutter fixed on a sidewall of the fitting base so as to form a function of a camera for taking photos and pictures.

### BRIEF DESCRIPTION OF DRAWINGS

This invention will be better understood by referring to the accompanying drawings, wherein:

FIG. 1 is a perspective view of a conventional iPod;

FIG. 2 is a perspective view of an iPod's additional function device separated from an iPod in the present invention;

FIG. 3 is a perspective view of an iPod combined with the iPod's additional function device in the present invention;

FIG. 4 is an upper view of the iPod with the iPod's additional function device in the present invention;

FIG. 5 is a front view of the iPod with the iPod's additional function device in the present invention; and,

FIG. 6 is a right side view of the iPod with the iPod's additional function device in the present invention.

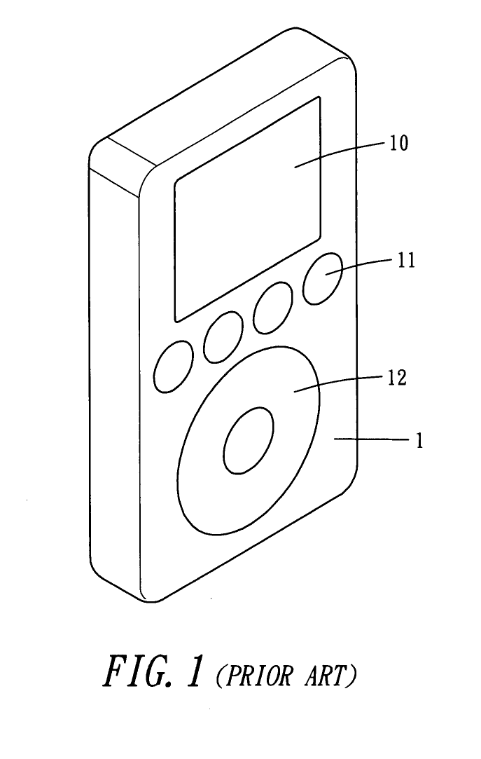

### DETAILED DESCRIPTION OF THE PREFERRED EMBODIMENT

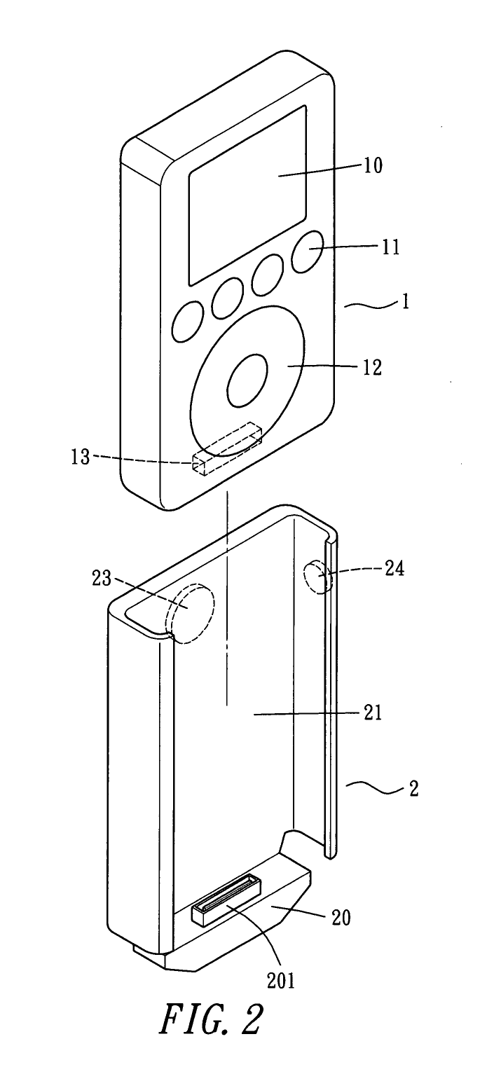

A preferred embodiment of an iPod's additional function device in the present invention, as shown in FIG. 2, includes an iPod's body 1, a connection interface 13 formed in a lower end of the body 1 for transmitting data, and a fitting base 2 fitting with a rear sidewall of the body 1 and provided with a bottom base 20, an interface adapter 201 fixed on an upper side of the bottom base 20 and matching with the connection interface 13 for transmitting data into the iPod, a lens 23 fixed on an inner wall of the fitting base 2 and a shutter 24 fixed on a sidewall of the fitting base 2 to control the lens 23 for taking photos. The fitting base 2 is provided with a main wall and two vertical sidewalls extending forward from two vertical sides of the main wall for defining a hollow space 21 with the main wall, the two sidewall and the bottom base 20 for the iPod's body 1 to be received therein. So the fitting base 2 has an open front side and an open upper side.

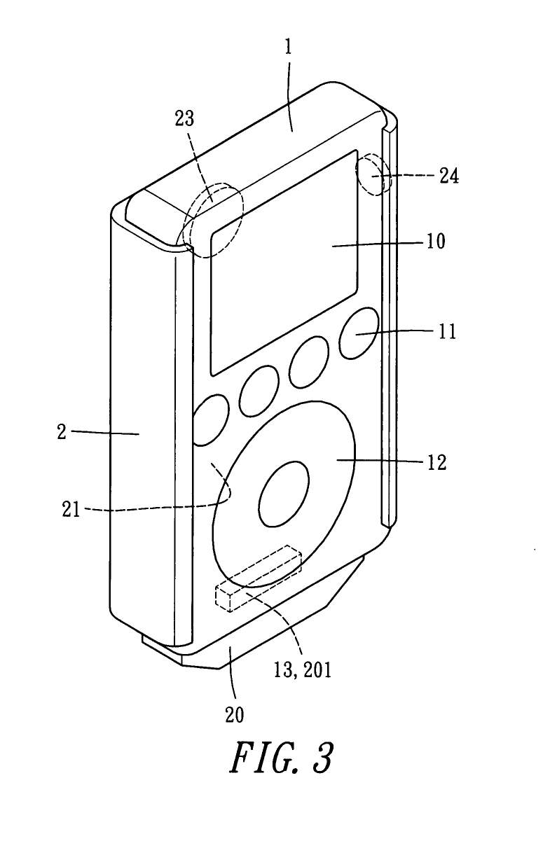

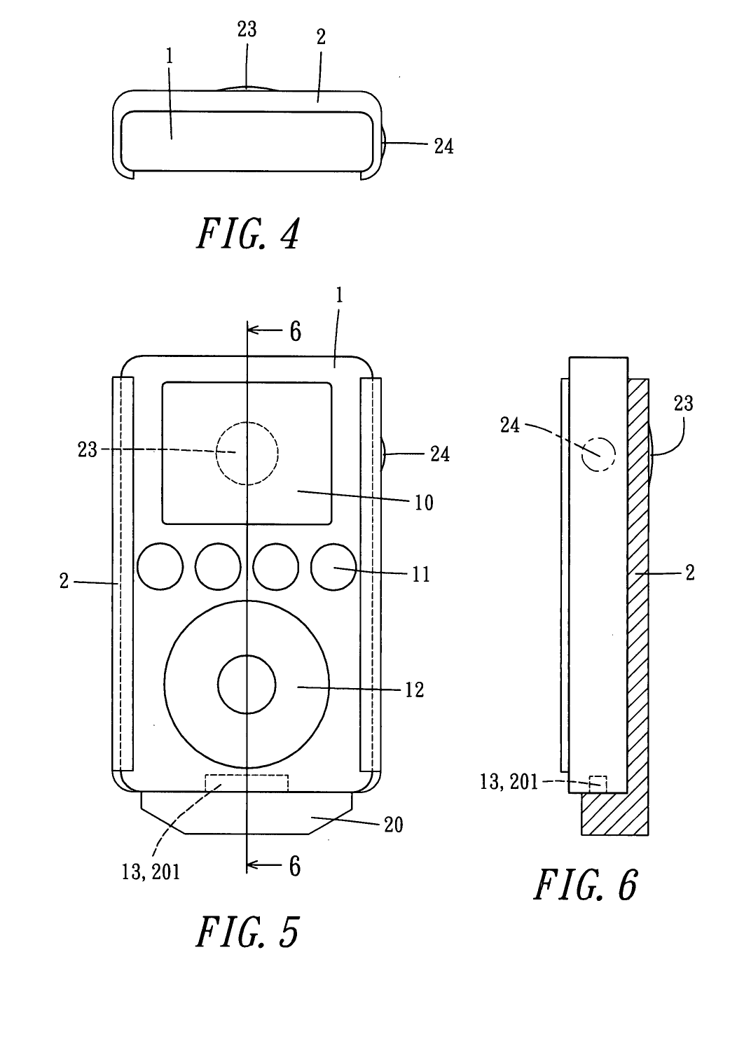

In using, as shown in FIGS. 3-6, the iPod's body 1 is slidingly inserted from the open upper side of the fitting base 2 into a hollow space 21, letting the connection interface 13 fitting with the interface adapter 201 of the fitting base 2 so that the lens 23 of the fitting base 2 may transfer an image it takes via the interface adapter 201 and the connection interface 13 to be loaded in the memory of the body 1. Then the shutter 24 is instantly opened to let the image pass through the lens 23 and then loaded in the memory and then possible to be retrieved and shown on the display screen 10 of the body 1 later. In case of retrieving the image from the memory, the function of the iPod itself enables the stored data in the memory retrieved to be shown on the display screen 10 anytime.

Further, instead of the interface adapter 201, another transmitting adapter can be matched with the connection interface 13 for showing data from other sources such as VCR, DVD or TV to be loaded in the memory and then possible to retrieve the data therein on the display screen 10 and at the same time send the sound via the earphones connected to the iPod when necessary.

While the preferred embodiment of the invention has been described above, it will be recognized and understood that various modifications may be made therein and the appended claims are intended to cover all such modifications that may fall within the spirit and scope of the invention.

What is claimed is:

1. An iPod's additional function device comprising a fitting base, a lens fixed on an inner wall of said fitting base, and a shutter fixed on said fitting base for controlling said lens so that an iPod provided with said additional function device may have a function of a camera for taking photos in addition to original functions that said iPod has.

2. The iPod's additional function device as claimed in claim 1, wherein said fitting base has an open front side and an open upper side to define a hollow space for an iPod to be slidingly inserted in said hollow space through said open upper side.

3. The iPod's additional function device as claimed in claim 1, wherein said fitting base has an interface adapter fixed at a lower side for connecting to an iPod.

4. The iPod's additional function device as claimed in claim 1, wherein said fitting base has two sidewalls extending vertically forward from a main wall, and said two sidewalls can contact stably an edge of two opposite sides of an iPod so that iPod cannot randomly loosen out of said fitting base.

5. The iPod's additional function device as claimed in claim 1, wherein another transmitting adapter can be matched with said connection interface of said iPod′ body, and then said transmitting adapter connected to an broadcasting device so that video and audio data can be loaded via said transmitting adapter in a memory of an iPod and stored data can be retrieved to be shown on a display screen of said iPod anytime.
